(19) United States
(12) Patent Application Publication
(10) Pub. No.: US 2018/0181621 A1
(43) Pub. Date: Jun. 28, 2018

(54) MULTI-LEVEL RESERVOIR SAMPLING OVER DISTRIBUTED DATABASES AND DISTRIBUTED STREAMS

(71) Applicant: Teradata US, Inc., Dayton, OH (US)

(72) Inventors: Mohammed Hussein Al-Kateb, Rolling Hills Estates, CA (US); Olli Pekka Kostamaa, Santa Monica, CA (US)

(73) Assignee: Teradata US, Inc., Dayton, OH (US)

(21) Appl. No.: 15/388,300

(22) Filed: Dec. 22, 2016

(51) Int. Cl. G06F 17/30; G06N 7/00

(52) U.S. Cl. CPC G06F 17/30516; G06N 7/005; G06F 17/30595

(57) ABSTRACT

A system and method for random sampling of distributed data, including distributed data streams. The system and method use a multi-level reservoir sampling technique that leverages the conventional reservoir sampling algorithm for distributed data or distributed data streams. The method establishes an intermediate reservoir for each distributed data source or data stream and populates the intermediate reservoirs with a sample of data elements received from each distributed data source or data stream. A final reservoir is established and data elements are randomly selected from each one of the intermediate reservoirs to populate the final reservoir.

### FIELD OF THE INVENTION

The present invention relates to random sampling within distributed processing systems with very large data sets, and more particularly, to an improved system and method for reservoir sampling of distributed data, including distributed data streams.

### BACKGROUND OF THE INVENTION

Random sampling has been widely used in database applications. A random sample can be used, for instance, to do sophisticated analytics on a small portion of data, which, otherwise, would be prohibitively expensive to apply on terabytes or petabytes of data. In this era of Big Data, data becomes virtually unlimited and should be processed as unbounded streams. Data has also became more and more distributed as evident by recent processing models such as MapReduce.

A random sample is a subset of data that is statistically representative of an entire data set. When the data is centralized and its size is known prior to sampling, it is fairly straightforward to obtain a random sample. However, many applications deal with data that is both distributed and never-ending. One example is distributed data stream applications, such as sensor networks. Random sampling for this kind of application becomes more difficult due to two main reasons. First, the size of the data is unknown; hence, it is not possible to predetermine sampling probability before sampling starts. Second, data is distributed by nature and accordingly, it is not feasible to redistribute or duplicate the data to a central processing unit to do sampling. These two challenges combined bring the question of how to obtain a random sample of distributed data efficiently while guaranteeing the sample uniformity. Described below is a novel technique that addresses this problem. The devised technique is applicable to traditional distributed database systems, distributed data streams, and modern processing models such as MapReduce. This solution is easily implemented within a Teradata Unified Data Architecture™ (UDA), illustrated in FIG. 1, either in a Teradata database, Teradata Aster database, or any Hadoop databases or data streams; as well as in other commercial and open-source database and Big Data platforms.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of a Teradata Unified Data Architecture (UDA) system.

FIG. 2 is a simple illustration showing data streams from various data sources to a Teradata UDA system.

FIG. 3 is an illustration of a process for performing reservoir sampling from a data stream.

FIG. 4 is an illustration of a process for performing two-step sampling from multiple or distributed data streams, in accordance with the present invention.

FIG. 5 is another illustration of a process for performing two-set sampling from multiple or distributed data streams, in accordance with the present invention.

### DETAILED DESCRIPTION OF THE INVENTION

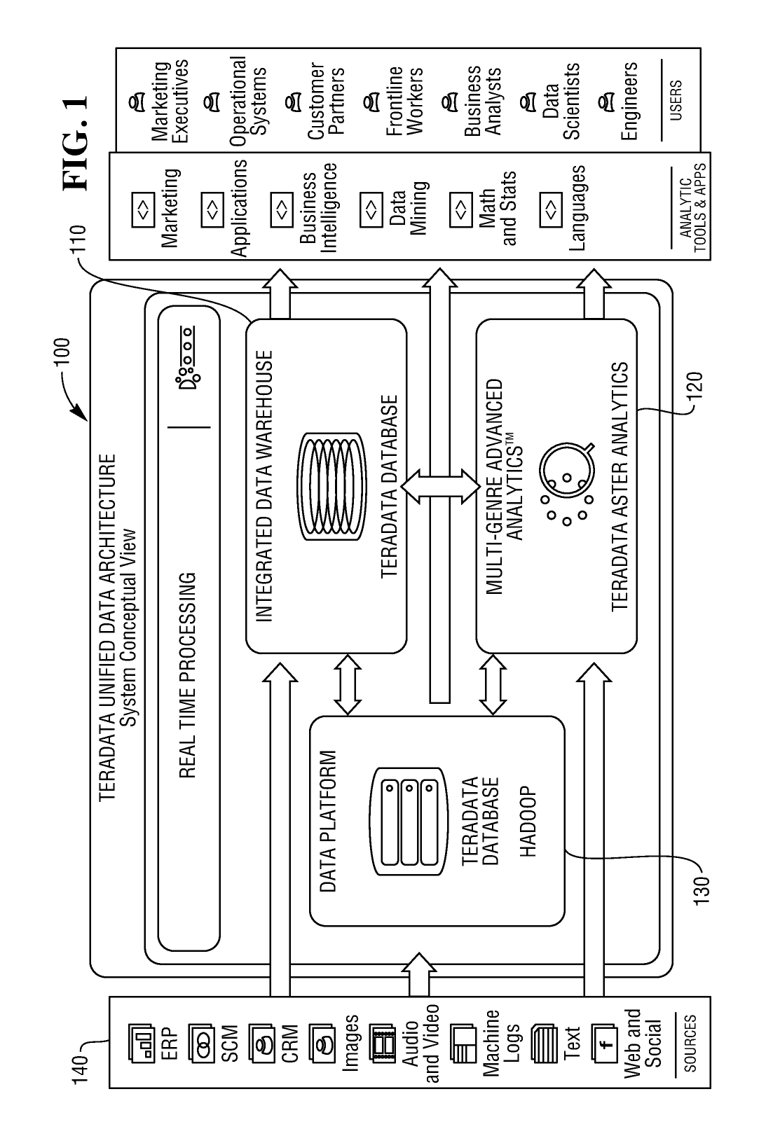

The data sampling techniques described herein can be used to sample table data and data streams within a Teradata Unified Data Architecture™ (UDA) system 100, illustrated in FIG. 1, as well as in other commercial and open-source database and Big Data platforms. The Teradata Unified Data Architecture (UDA) system includes multiple data engines for the storage of different data types, and tools for managing, processing, and analyzing the data stored across the data engines. The UDA system illustrated in FIG. 1 includes a Teradata Database System 110, a Teradata Aster Database System 120, and a Hadoop Distributed Storage System 130.

The Teradata Database System 110 is a massively parallel processing (MPP) relations database management system including one or more processing nodes that manage the storage and retrieval of data in data storage facilities. Each of the processing nodes may host one or more physical or virtual processing modules, referred to as access module processors (AMPS). Each of the processing nodes manages a portion of a database that is stored in a corresponding data storage facility. Each data-storage facility includes one or more disk drives or other storage medium. The system stores data in one or more tables in the data-storage facilities wherein table rows may be stored across multiple data storage facilities to ensure that the system workload is distributed evenly across the processing nodes 115. Additional description of a Teradata Database System is provided in U.S. patent application Ser. No. 14/983,804, titled “METHOD AND SYSTEM FOR PREVENTING REUSE OF CYLINDER ID INDEXES IN A COMPUTER SYSTEM WITH MISSING STORAGE DRIVES” by Gary Lee Boggs, filed on Dec. 30. 2015, which is incorporated by reference herein.

The Teradata Aster Database 120 is also based upon a Massively Parallel Processing (MPP) architecture, where tasks are run simultaneously across multiple nodes for more efficient processing. The Teradata Aster Database includes multiple analytic engines, such as SQL, MapReduce, and Graph, designed to provide optimal processing of the analytic tasks across massive volumes of structured, non-structured data, and multi-structured data, referred to as Big Data, not easily processed using traditional database and software techniques. Additional description of a Teradata Aster Database System is provided in U.S. patent application Ser. No. 15/045,022, titled “COLLABORATIVE PLANNING FOR ACCELERATING ANALYTIC QUERIES” by Derrick Poo-Ray Kondo et al., filed on Feb. 16, 2016, which is incorporated by reference herein.

The Teradata UDA system illustrated in FIG. 1 also includes an open source Hadoop framework 130 employing a MapReduce model to manage distributed storage and distributed processing of very large data sets. Additional description of a data warehousing infrastructure built upon a Hadoop cluster is provided in U.S. patent application Ser. No. 15/257,507, titled “COLLECTING STATISTICS IN UNCONVENTIONAL DATABASE ENVIRONMENTS” by Louis Martin Burger, filed on Sep. 6, 2016, which is incorporated by reference herein. The Hadoop distribution may be one provided by Cloudera, Hortonworks, or MapR.

The Teradata UDA System 100 may incorporate or involve other data engines including cloud and hybrid-cloud systems.

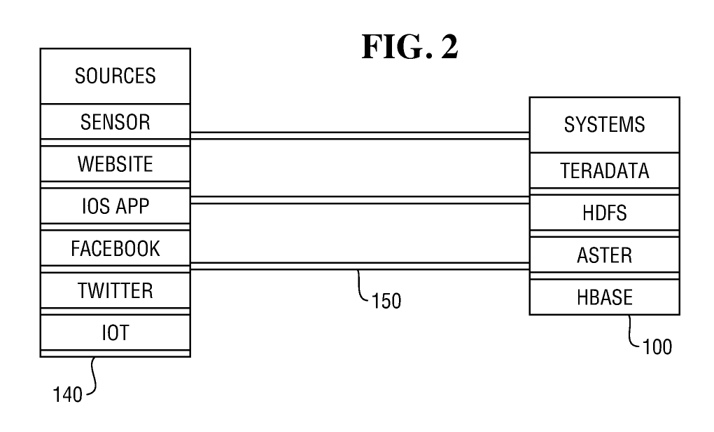

Data sources 140 shown in FIG. 1 may provide Enterprise Resource Planning (ERP), Supply Chain Management (SCM), Customer Relationship Management (CRM), Image, Audio and Video, Machine Log, Text, Web and Social, Sensor, Mobile App, and Internet of Things (IoT) data to UDA system 100. FIG. 2 provides a simple illustration showing multiple data streams 150 from various data sources 140 to Teradata UDA system 100. As stated earlier, distributed data streams and data distributed across multiple data engines and storage devices presents a number of challenges to performing data sampling.

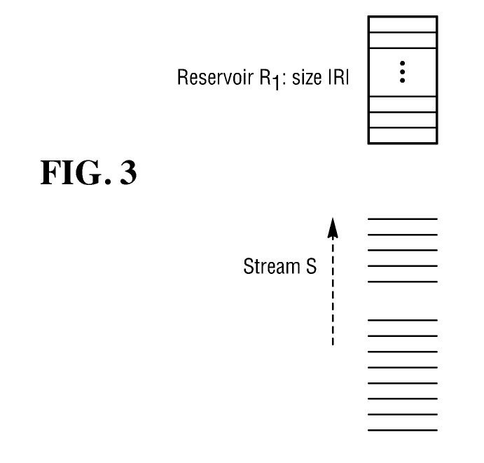

A very well-known technique for sampling over data streams is reservoir sampling. A reservoir sample always holds a uniform random sample of data collected thus far. This technique has been used in many database applications, such as approximate query processing, query optimization, and spatial data management. FIG. 3 provides an illustration of this process, wherein a reservoir R of size |R| is used to sample a data stream S. In the beginning, a reservoir sampling algorithm retains the first |R| elements from data stream S into reservoir R. After that, each following k^{th} element is sampled with the probability |R|/k, with each sampled element taking the place of a randomly selected element in R. An implementation of this replacement algorithm is as follows: For each element k, assign a random number r, where 1<=r<=k. If r<=|R|, then replace the r^{th} element of R with the new element k.

Additional description of reservoir sampling is provided in the paper titled “Random sampling with a reservoir” by Jeffrey S. Vitar presented in ACM Transactions on Mathematical Software, Vol. 11, No. 1, March 1985, Pages 35-57.

Described herein is a novel reservoir-based sampling technique that leverages the conventional reservoir sampling algorithm for distributed data. A typical application for the devised technique is distributed data streams applications. In these applications, multiple data streams are being generated, for instance, from distributed deployed sensors. The processing unit of each sensor node needs to sample from its data stream individually, and a final sample needs to be generated which represents all data streams.

A primary concern with generating a final sample from multiple data stream samples is the maintenance of the uniformity of the final sample while each data stream is sampled independently. To illustrate this problem, assume a random sample R of size |R| from two data streams S₁ and S₂, where |S₁| and |S₂| denote the number of data elements generated so far from S₁ and S₂, respectively. The straightforward approach for generating a sample from the two data streams is to redistribute one data stream to another and take a random sample of |R| from a data set of size |S₁|+|S₂|. Note that in this case, there are

$$( \begin{matrix}\vert S 1 \vert + \vert S 2 \vert \\ \vert R \vert\end{matrix} )$$

different possible samples of size |R| that can be selected from |S₁|+|S₂| elements. Without redistribution, each of the streams S₁ and S₂ needs to be sampled individually. Assume that two random samples are drawn independently from S₁ and S₂ such that the size of sample is proportional to the number of elements seen from each stream thus far and, then, both samples are combined to produce R. That is to say, |R₁|=|R|(|S₁|/(|S₁|+|S₂|)) and |R₂|=|R|(|S₂|/(|S₁|+|S₂|)). In this case, the number of different samples that can be eventually obtained is

$$( \begin{matrix}\vert S 1 \vert \\ \vert R 1 \vert\end{matrix} ) ( \begin{matrix}\vert S 2 \vert \\ \vert R 2 \vert\end{matrix} )$$

such that |R₁|+|R₂|=|R₁. It is clear that this number

$$( \begin{matrix}\vert S 1 \vert \\ \vert R 1 \vert\end{matrix} ) ( \begin{matrix}\vert S 2 \vert \\ \vert R 2 \vert\end{matrix} )$$

is less than

$$( \begin{matrix}\vert S 1 \vert + \vert S 2 \vert \\ \vert R \vert\end{matrix} ) ,$$

which indicates that there are some possible random samples that cannot be generated following this method. To insure uniformity, a sampling technique has to generate as many possible combinations as the straightforward approach would generate.

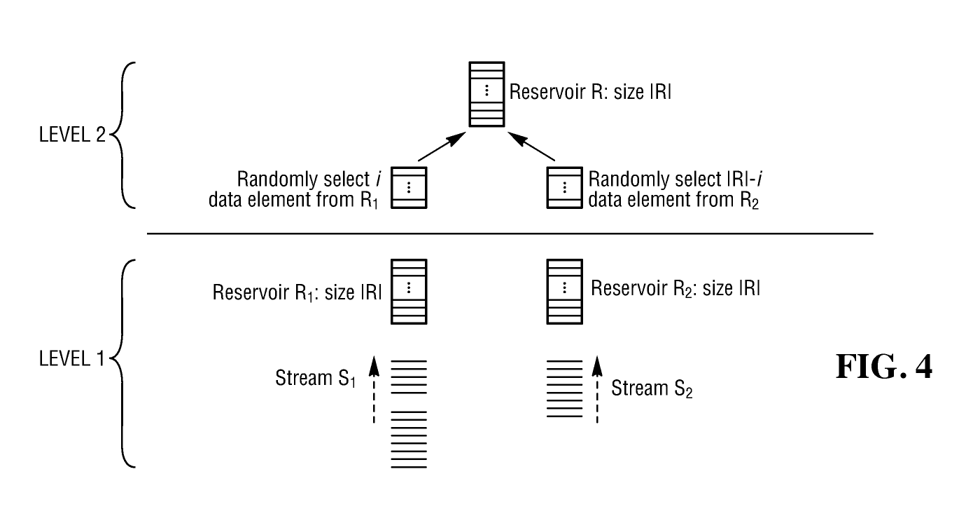

The proposed novel multi-level reservoir sampling technique, illustrated in FIG. 4, achieves this required uniformity in two levels of sampling. In the first level, Level 1, the multi-level reservoir sampling technique draws a reservoir sample of size |R| from each of two data streams, S₁ and S₂, independently. The reservoirs corresponding to data streams S ₁ and S₂ streams are identified as R₁ and R₂, respectively. Note that specifying each of the reservoirs as |R| is essential to uniformity as this yields the possibility that all elements can come from one single data stream, which is one possibility under a straightforward uniform random sampling scheme. In the second level, Level 2, given the two samples R₁ and R₂, both of size |R|, a random number between 0 and |R| is generated. This random number is denoted as i. The improved reservoir sampling technique randomly selects i elements from R₁ (i.e., S₁) and |R|-i elements from R₂ (i.e., S₂). The value of i is selected from a probability function

$$( \begin{matrix}\vert S 1 \vert \\ i\end{matrix} ) ( \begin{matrix}\vert S 2 \vert \\ \vert R \vert - i\end{matrix} ) / ( \begin{matrix}\vert S 1 \vert + \vert S 2 \vert \\ \vert R \vert\end{matrix} ) .$$

Since i can be anywhere from 0 to |R|, this means that the number of possible random sample combinations that can be generated using the proposed technique

$${\sum }_{i = 0}^{\vert R \vert} ( \begin{matrix}\vert S 1 \vert \\ i\end{matrix} ) ( \begin{matrix}\vert S 2 \vert \\ \vert R \vert - i\end{matrix} ) .$$

This, therefore, verifies that the proposed multi-level sampling technique guarantees the uniformity of sample.

A key property of the multi-level sampling technique is that it achieves 100% uniformity in the final sample while taking into consideration the proportion of data from which the sample is drawn. Consider the following example assuming two streams S₁ and S₂, where the number of data elements seen from S₁ is 10 and from S₂ is 5, and random sample of size 4 is desired. It is expected that more data elements will be selected from S₁ than from S₂ as S₁ has more elements. The improved multi-level reservoir sampling technique achieves this result when it decides on how many elements to select from each intermediate, or Level 1, reservoir using the probability function discussed above. Table 1 shows the probability of selecting a certain number of elements from Stream S₁:

TABLE 1
Probability of selecting i elements from S₁

| | $( \begin{matrix}10 \\ i\end{matrix} ) ( \begin{matrix}5 \\ 4 - i\end{matrix} ) \text{/} ( \begin{matrix}10 + 5 \\ 4\end{matrix} )$ |
|---|---|
| p (i = 0) | 0.003663 |
| p (i = 1) | 0.07326 |
| p (i = 2) | 0.32967 |
| p (i = 3) | 0.43956 |
| p (i = 4) | 0.153846 |
| sum | 1 |

Note two points about the data in Table 1. First, the highest probability is to select 3 elements from S₁ and the remainder (which in this case is 4−3=1) from S₂. This means that the algorithm favors S₁ over S₂ because Sᵢ has more elements. Second, the sum of all probabilities equals to 1. This demonstrates that uniformity is achieved by the sampling algorithm because it indicates that using the devised algorithm results in the same number of different random samples of size 4 that can be obtained from combining S₁ and S₂ together before sampling.

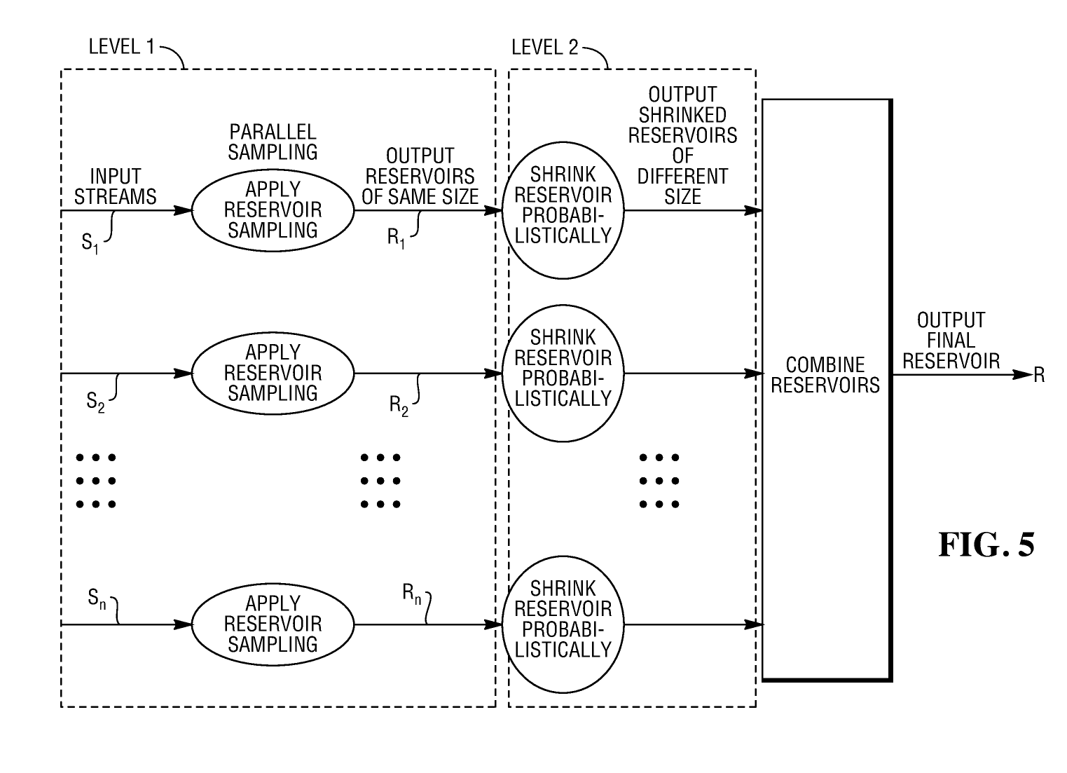

The sampling technique illustrated in FIG. 4 and described herein is not limited to generating a reservoir sample from two data streams or sources. FIG. 5 illustrates of a process for performing sampling from multiple distributed data sources or streams. In the first level, Level 1, the multi-level reservoir sampling technique draws a reservoir sample of size |R| from each of n data streams, S₁, S₂, . . . Sₙ, independently. The reservoirs corresponding to data streams S₁, S₂, . . . Sₙ, streams are identified as R₁ , R₂, . . . Rₙ, respectively. In the second level, Level 2, the aforementioned probabilistic technique is employed to randomly extract data elements from reservoirs R₁ , R₂, . . . Rₙ, which are combined to produce the final output reservoir R.

The multi-level sampling technique described above and illustrated in the figures addresses an important problem in an efficient manner As aforementioned, random sampling is an indispensable functionality to any data management system. With data continuously evolving and naturally being distributed, this improved sampling technique becomes even more important. It is theoretically proven and practically implementable. It can be implemented for traditional distributed database systems, distributed data streams, and modern processing models (e.g., MapReduce). It is easily implemented in a commercial and open-source database and big data systems, such as the Teradata Unified Data Architecture™ (UDA), illustrated in FIG. 1, a Teradata Aster database, or any Hadoop distributed databases or data streams.

The foregoing description of the invention has been presented for purposes of illustration and description. It is not intended to be exhaustive or to limit the invention to the precise form disclosed.

Additional alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A method for generating a random sample of data elements from multiple data sources, the method comprising:
receiving, using a computer processor, from each of said multiple data sources, a sample of data elements;
for each one of the multiple data sources, establishing in a memory an intermediate sampling reservoir and populating using said computer processor the intermediate sampling reservoir with the sample of data elements received from said one of the multiple data sources; and
establishing a final sampling reservoir and randomly selecting data elements by said computer processor from each one of said intermediate sampling reservoirs and populating said final sampling reservoir with said randomly selected data elements.

2. The method in accordance with claim 1, wherein each of said intermediate and final reservoirs has an equivalent size.

3. The method in accordance with claim 1, wherein said multiple data sources comprise data storage devices within a distributed data processing system.

4. The method in accordance with claim 3, wherein said distributed data processing system comprises a relational data processing system.

5. The method in accordance with claim 3, wherein said distributed data processing system comprises a MapReduce system.

6. A method for generating a random sample of data elements from multiple data streams, the method comprising:
receiving, using a computer processor, from each of said multiple data streams, a sample of data elements;
for each one of the multiple data streams, establishing in a memory an intermediate sampling reservoir of an equivalent size and populating using said computer processor the intermediate sampling reservoir with the sample of data elements received from said one of the multiple data streams; and
establishing in memory a final sampling reservoir of said equivalent size and randomly selecting by said computer processor data elements from each one of said intermediate sampling reservoirs and populating said final sampling reservoir with said randomly selected data elements.

7. The method in accordance with claim 6, wherein:
said multiple data streams provide data elements at different rates; and
said step of randomly selecting data elements from each one of said intermediate sampling reservoirs to populate said final sampling reservoir employs probabilistic techniques to weight said selection of data elements from said multiple data streams according to said different rates.

8. A system for generating a random sample of data elements from multiple data sources, the system comprising:
a computer processor for receiving from each of said multiple data sources, a sample of data elements;
an intermediate sampling reservoir established within a computer memory for each one of the multiple data sources, each one of said intermediate sampling reservoirs being populated by said computer processor with the sample of data elements received from said one of the multiple data sources; and
a final sampling reservoir established within said computer memory, said final sampling reservoir being populated by said computer processor with a random selection of data elements from each one of said intermediate sampling reservoirs.

9. The system in accordance with claim 8, wherein each of said intermediate and final reservoirs has an equivalent size.

10. The system in accordance with claim 8, wherein said multiple data sources comprise data storage devices within a distributed data processing system.

11. The system in accordance with claim 10, wherein said distributed data processing system comprises a relational data processing system.

12. The system in accordance with claim 10, wherein said distributed data processing system comprises a MapReduce system.

13. A system for generating a random sample of data elements from multiple data streams, the method comprising:
a computer processor for receiving a sample of data elements from each one of said multiple data streams;
an intermediate sampling reservoir established within a computer memory for each one of the multiple data sources, each one of said intermediate sampling reservoirs having an equivalent size and being populated by said computer processor with the sample of data elements received from said one of the multiple data streams; and
a final sampling reservoir established within said computer memory, said final sampling reservoir having said equivalent size as said intermediate sampling reservoirs, said final sampling reservoir being populated by said computer processor with a random selection of data elements from each one of said intermediate sampling reservoirs.

14. The system in accordance with claim 13, wherein:
said multiple data streams provide data elements at different rates; and
data elements are selected from each one of said intermediate sampling reservoirs to populate said final sampling reservoir using probabilistic techniques to weight said selection of data elements from said multiple data streams according to said different rates.

15. A system for generating a random sample of data elements from multiple data streams, the method comprising:
a computer processor for receiving a stream of data elements from a first data stream;
a first sampling reservoir established within a computer memory and populated with a sample of data elements received from said first data stream;
said computer processor receiving a stream of data elements from a second data stream;
a second sampling reservoir established within said computer memory and populated with a sample of data elements received from said second data stream; and
a third sampling reservoir established with said computer memory and populated with a random selection of data elements from said first and second sampling reservoirs.

16. The system in accordance with claim 15, wherein:
said multiple data streams provide data elements at different rates; and
data elements are selected from said first and second sampling reservoirs to populate said third sampling reservoir using a probabilistic technique to weight said selection of data elements from said first and second sampling reservoirs according to said different rates.
